(19) United States
(12) Patent Application Publication
(10) Pub. No.: US 2014/0123916 A1
(43) Pub. Date: May 8, 2014

(54) Utilizing Locomotive Electrical Locker to Warm Liquid Natural Gas

(71) Applicant: ELECTRO-MOTIVE DIESEL, INC., LaGrange, IL (US)

(72) Inventors: Dana R. Coldren, Secor, IL (US); Aaron G. Foege, Westmont, IL (US)

(73) Assignee: Electro-Motive Diesel, Inc., LaGrange, IL (US)

(21) Appl. No.: 13/669,334

(22) Filed: Nov. 5, 2012

(51) Int. Cl. F02M 21/06; F02B 43/10; F17C 13/08; F17C 9/02

(52) U.S. Cl. CPC F02M 21/06; F17C 9/02; F02B 43/10; F17C 13/084
USPC 123/3; 62/50.2; 62/50.6; 123/526

(57) ABSTRACT

A system for the exchange of thermal energy generated by electrical components in an electrical locker to a flow of a liquefied gas is provided. The system includes a storage container for cryogenically storing the liquefied gas at low pressure, a heat exchanger configured into the electrical locker, and a cryogenic pump in fluid communication with the storage container. The cryogenic pump pressurizes the liquefied gas received from the storage container to a higher pressure and pumps the pressurized liquefied gas to a location where vaporization of the liquefied gas into a gaseous form is performed using the thermal energy drawn from the electrical locker by the heat exchanger.

### TECHNICAL FIELD

The disclosure relates to heat exchange systems and methods for warming of cryogenic liquid natural gas prior to introduction into an internal combustion engine. More particularly, the disclosure relates to heat exchange systems for the efficient transfer of heat generated by a locomotive's electrical system into a cryogenic liquid natural gas stream.

### BACKGROUND

Conventional railroad locomotives are powered by an internal combustion engine that drives one or more electrical generators that in turn provide power to a series of traction motors for applying traction effort to the drive wheels. Typically, the internal combustion engine in a conventional locomotive is a diesel engine that relies on large quantities of diesel fuel to run. Increased environmental concerns and the accelerated rise in the general cost of diesel fuel have spurred significant development in the way of alternative fuels for locomotive engines. Fuels, such as Compressed Natural Gas (CNG), Liquefied Natural Gas (LNG), Liquefied Petroleum Gas (LPG), Liquefied Propane (LP), or Refrigerated Liquid Methane (RLM), provide environmentally cleaner alternatives to diesel fuel and are increasingly more economical as the rising cost of the diesel reformulations required for today's cleaner burning engines continues to outpace the cost of these abundant alternative fuels.

The locomotive industry has been developing natural gas engine technologies to accommodate the push for alternative fuels. Engines have been developed that depend entirely on natural gas to run, while yet other hybrid engines have been developed to have dual-fuel capability, wherein the engine may be supplied with natural gas and/or diesel fuel to run. CNG has been used as a fuel for these natural gas supplied locomotive engines. However, CNG has a low energy density, which makes it a difficult fuel to use, particularly in the railroad industry where long distance travel requires large fuel reserves. The low energy density, combined with the high-pressure storage requirements of CNG (typically upwards of 200 to 250 bar), require large, heavy, reinforced storage containers that are costly and inefficient. LNG, on the other hand, has an energy density 2.4 times heavier than that of CNG or 60% of diesel fuel and can be stored at much lower pressures than CNG (typically less than 10 bar). As such, the locomotive industry is increasingly looking to LNG as a viable alternative fuel choice. Special tender cars have been developed that have specially designed cryogenic vessels for storing the LNG at low pressure and at temperatures of between about −320° F. (−160° C.) and −265° F. (−130° C.). The vessels are thermally insulated and can be comprised of multiple shells in order to reduce heat transfer into the LNG from the surroundings. Special equipment, such as vaporizers and cryogenic pumps, are used to warm the LNG in order to convert the LNG into a gaseous state and/or to deliver the gas to the engine at an appropriate pressure.

Various heat transfer systems for converting a liquid gas into the gaseous state for use in an internal combustion engine have been proposed, such as in U.S. Pat. No. 7,841,322, which is directed toward a chiller assembly for a diesel engine. An incoming air charge for the engine is cooled or supercooled by introducing liquid propane into the chiller assembly and passing the air charge through the chiller. The incoming air charge is cooled by the liquid propane while the liquid propane is warmed by the incoming air charge, converting the liquid propane into a gaseous state for injection into the engine. In other conventional systems, heat is pulled from the engine coolant to warm the liquid natural gas prior to introduction into the internal combustion engine.

Due to the enormous heat loads generated on a locomotive, particularly under certain circumstances, a need exists for specially designed heat exchange systems that may simultaneously obtain the cooling benefits of a cryogenically delivered liquid while serving the function of vaporizer for converting the cryogenically delivered liquid to a gaseous state for use in the diesel engine. For example, the electrical generators driven by the diesel engine also provide power for battery charging, air conditioning/heating, blowers, cooling fans, various pumps and control circuits. The electrical components of the locomotive are often arranged in an electrical locker for protection and ease of access. It is necessary to control the environmental parameters of the electrical locker to ensure the proper functioning of the electrical equipment and to prevent exposure of the electrical equipment to excessive heat. Typically, fans, blowers, and special filters are provided to control the environment in the electrical locker and prevent overheating of the electrical equipment arranged therein.

However, these conventional cooling systems usually rely on air drawn from an ambient source to provide a heat exchange medium. When a locomotive is hauling a heavy load through a long tunnel, for example, the temperature of the ambient air can significantly and dramatically increase to the point that the conventional cooling means for the electrical locker can quickly be overwhelmed, resulting in damage to the electrical components. Accordingly, a heat exchange system is needed to simultaneously obtain the cooling benefits of a cryogenically delivered liquid for cooling the electrical components of a locomotive while serving the function of vaporizer for converting the cryogenically delivered liquid to a gaseous state for use in the locomotive's natural gas engine. The heat exchange system may be the primary and/or secondary cooling source for the electrical components stored in an electrical locker on the natural gas locomotive.

### SUMMARY

The foregoing needs are met, to a great extent, by the disclosure, wherein in accordance with one embodiment a system for the exchange of thermal energy generated by electrical components in an electrical locker to a flow of a liquefied gas includes a storage container for cryogenically storing the liquefied gas at low pressure, a heat exchanger configured into the electrical locker, and a cryogenic pump, in fluid communication with the storage container, for pressurizing the liquefied gas received from the storage container to a higher pressure and for pumping the pressurized liquefied gas to a location where vaporization of the liquefied gas into a gaseous form is performed using the thermal energy drawn from the electrical locker by the heat exchanger.

In accordance with one embodiment a vehicle comprises a system for the exchange of thermal energy generated by electrical components in an electrical locker to a flow of a liquefied gas includes a storage container for cryogenically storing the liquefied gas at low pressure, a heat exchanger configured into the electrical locker, and a cryogenic pump in fluid communication with the storage container and the heat exchanger for pressurizing the liquefied gas received from the storage container to a higher pressure and pumping the pressurized liquefied gas to the heat exchanger for vaporization of the liquefied gas into a gaseous form using the thermal energy drawn from the electrical locker.

In accordance with one embodiment a method of supplying gaseous fuel to an internal combustion engine on a locomotive includes coupling a tender car to the locomotive, pumping a liquefied gas from a storage container on the tender car to a heat exchanger configured into an electrical locker on the locomotive, vaporizing the liquefied gas in the heat exchanger using thermal energy drawn from the electrical locker, and injecting the vaporized liquefied gas into the internal combustion engine.

### BRIEF DESCRIPTION OF THE DRAWINGS

FIG. 1 is a top view of a locomotive, in accordance with aspects of the present disclosure;

FIG. 2 is a left side view of the locomotive shown in FIG. 1, in accordance with aspects of the present disclosure;

FIG. 3 is another cut away top view of the locomotive shown in FIG. 1, in accordance with aspects of the present disclosure;

FIG. 4 is a left side view of a locomotive and liquid natural gas tender car with a partial cutaway showing a prime mover power source that uses LNG (e.g., a high-pressure direct injection (HPDI) engine), in accordance with aspects of the present disclosure;

FIG. 5 is a perspective view of a configuration for a liquid natural gas tender car with a fuel management system module, in accordance with aspects of the present disclosure;

FIG. 6 is a perspective view of another configuration for a liquid natural gas tender car with a fuel management system module, in accordance with aspects of the present disclosure;

FIG. 7 is a side cutaway view of a heat exchange system on a natural gas locomotive coupled to a liquid natural gas tender car, in accordance with aspects of the present disclosure;

FIG. 8 is a side cutaway view of another heat exchange system on a natural gas locomotive coupled to a liquid natural gas tender car, in accordance with aspects of the present disclosure; and

FIG. 9 is a side cutaway view of yet another heat exchange system on a natural gas locomotive coupled to a liquid natural gas tender car, in accordance with aspects of the present disclosure.

### DETAILED DESCRIPTION

The disclosure will now be described with reference to the drawing figures, in which like reference numerals refer to like parts throughout.

Various aspects of systems and methods for utilizing a locomotive electrical locker to warm liquid natural gas may be illustrated by describing components that are connected, attached, and/or joined together. As used herein, the terms “connected”, “attached”, and/or “joined” are used to indicate either a direct connection between two components or, where appropriate, an indirect connection to one another through intervening or intermediate components. In contrast, if a component is referred to as being “directly coupled”, “directly attached”, and/or “directly joined” to another component, there are no intervening elements present.

Embodiments of the disclosure advantageously provide systems and methods for utilizing a locomotive electrical locker to warm liquid natural gas. The heat exchange systems described herein provide advantages for alleviating dangerous heat loading on a locomotive's electrical equipment while simultaneously providing a method for warming pressurized liquid natural gas prior to injection into an internal combustion engine. The systems and methods described herein are applicable for use with locomotives and, in particular, locomotives designed or converted to run on injected natural gas.

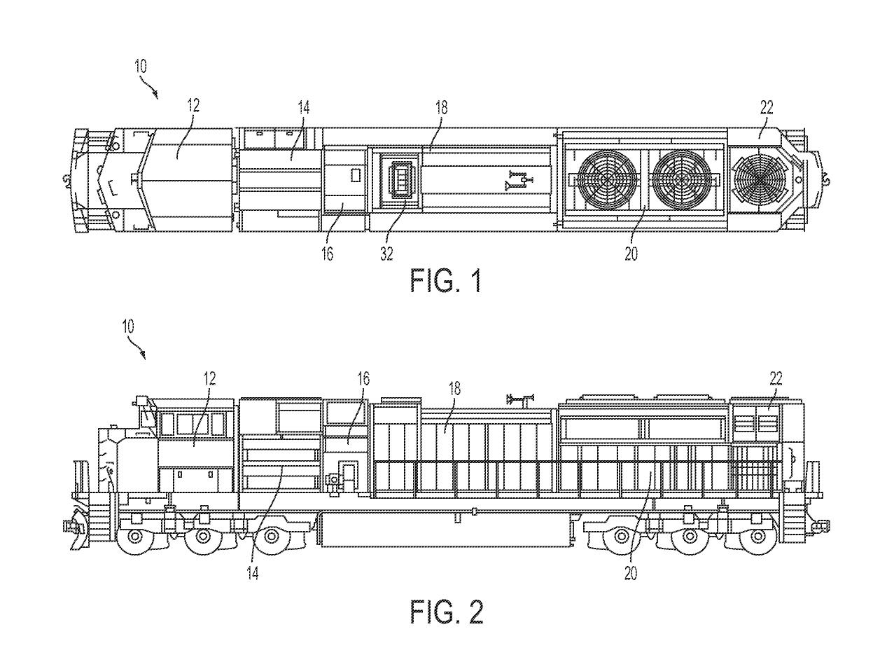

FIGS. 1 and 2 illustrate top and left side views of a locomotive 10 in accordance with aspects of the present disclosure. The locomotive 10 is designed for operating on a liquefied gas fuel, such as LNG. For example, the locomotive may have a prime mover source that is a dual-fuel, spark-ignited or direct injected locomotive engine, or any other internal or external reciprocating engine, such as a Stirling cycle or turbine engine. In accordance with certain aspects of the present disclosure, the locomotive 10 may have a high-pressure direct injection (HPDI) engine that relies on the injection of high-pressure gaseous fuel directly into the piston cylinder late in the compression stroke in order to emulate the efficiencies of a diesel engine. The locomotive 10 may be configured with a cab 12, an electrical locker 14, a generator compartment 16, an engine compartment 18, an engine cooling compartment 20 and a dynamic brake compartment 22.

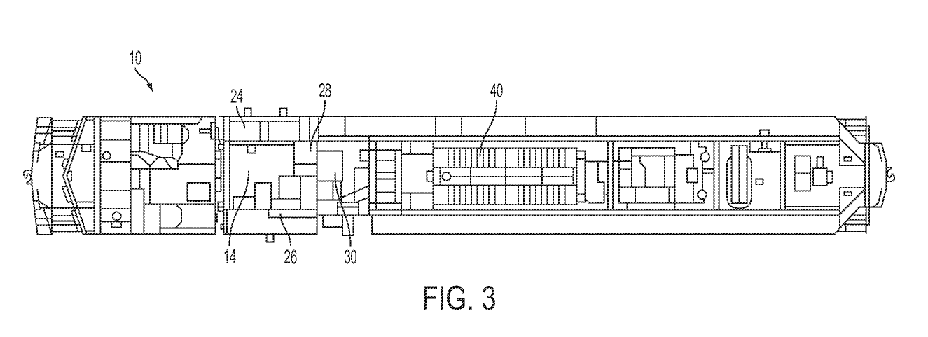

As shown in the cutaway top view of FIG. 3, the electrical locker 14 may house batteries 24, a power inverter 26, and other electrical components and systems for operation and control of the locomotive 10. Although lead acid batteries typically used on conventional locomotives are fairly insensitive to temperature, and thus may not be housed in the electrical locker 14, state of the art locomotive technology which employs hybrid-electric strategies may require batteries to be in the same clean and cool location as the rest of the sensitive electrical components. Electrical locker air filters 28 may be provided through which clean cool air may be received into the electrical locker 14 from a cooling air inlet 30. The cooling air inlet 30 may be fluidly connected to an inertial filter air inlet 32 (see FIG. 1) for drawing ambient air into the locomotive 10 for use as cooling air to the electrical locker 14 and/or for delivery to the prime mover source 40. Because the locomotive 10 relies on ambient air delivered by the inertial filter air inlet 32 to cool the various components in the electrical locker 14, there may be times during operation of the locomotive 10 when additional heat exchange systems may be necessary to prevent overheating of the electrical equipment and/or to ensure efficient operation of the electrical equipment. For example, operation of the locomotive 10 in a confined space, such as a tunnel, may create a situation in which the ambient air intake through the inertial filter air inlet 32 is no longer of a temperature cool enough to provide the required cooling.

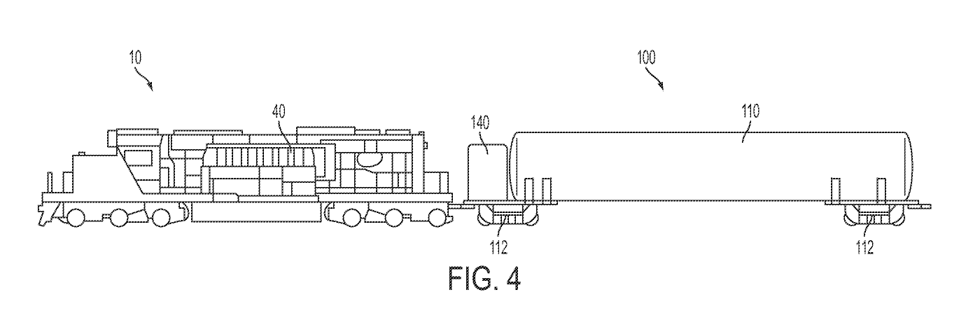

FIG. 4 illustrates the locomotive 10 coupled to a LNG tender car 100. In other aspects of the present disclosure, the locomotive 10 may be converted or constructed to have self-contained LNG reservoirs. However, a dedicated LNG tender car 100 has a proven safety record, many of the unique cryogenic components required to maintain the natural gas in a liquid state are easily maintained and accessible on the separate tender car, and the LNG tender car 100 may be interchangeable with multiple locomotive types. For example, the LNG tender car 100 may be used to supply fuel to the prime mover power source for the locomotive. In addition, there is limited space on modern locomotives for the additional storage required for LNG. The present LNG fueling infrastructure is limited and thus favors increasing the range of LNG powered trains rather than decreasing the range as would be required with limited LNG storage capacity on the locomotive itself.

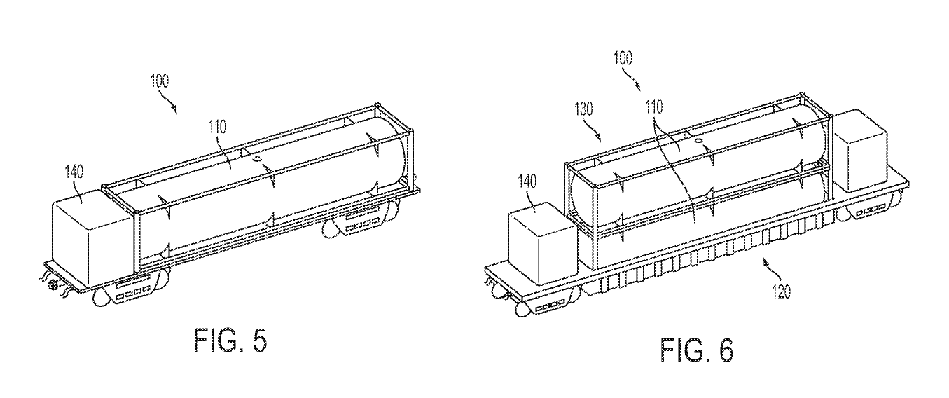

As shown in FIG. 4, the LNG tender car 100 may include a cryogenic storage container 110 situated on wheel trucks 112, for example. In accordance with aspects of the present disclosure, as shown in FIGS. 5 and 6, the LNG tender car 100 may include one or more LNG storage containers 110 that meet or exceed the regulations of the International Organization of Standardization (ISO) and are configured for loading onto a standard flatcar 120. The container 110 may be a specially designed cryogenic vessel having a double walled stainless steel structure, which may be vacuum insulated for storing the LNG at temperatures of between about −320° F. (−160° C.) and −265° F. (−130° C.) for up to ninety (90) days. The LNG tender car 100 optimizes LNG fuel storage capacity and insulation while providing convenient fuel transportation as a standard rail car. A tank holding frame 130 may be provided for supporting and protecting the storage containers 110 on the flatcar 120.

Delivery of natural gas fuel to the prime mover source 40 must be closely controlled and monitored. The LNG in the storage containers 110 is stored at low pressure and cryogenic temperatures. To supply a high pressure direct injection (HPDI) engine, for example, the LNG must be vaporized and delivered to the prime mover source 40 at high-pressures, typically above 200 bar, for direct injection into the combustion chambers.

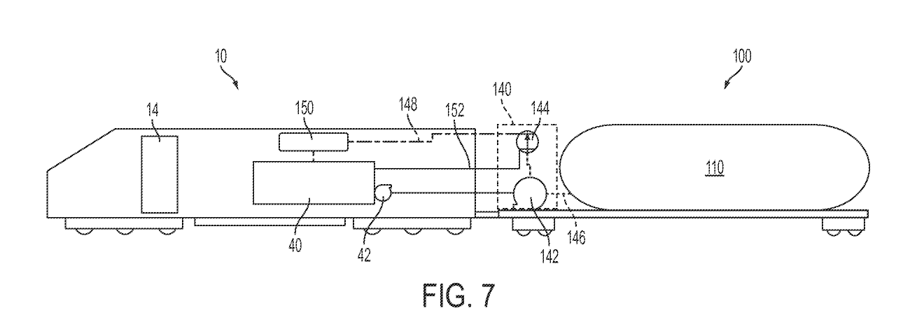

As shown in FIG. 7, a fuel management system 140 may be provided on the LNG tender car 100 that includes a cryogenic pump 142 for fuel pressurization, a vaporizer 144 for warming and vaporization of the pressurized liquid fuel, and controls and other gas hardware. A hydraulic pump 42, which may derive power directly from the prime mover source 40, for example, may be used to hydraulically drive the cryogenic pump 142. In accordance with other aspects of the present disclosure, an electric motor may be provided as part of the fuel management system 140 to drive the cryogenic pump 142. In accordance with yet other aspects of the present disclosure, the cryogenic pump 142 may be a reciprocating piston pump. In accordance with yet other aspects of the present disclosure, an auxiliary engine may be provided that can be configured to hydraulically or electrically drive the cryogenic pump 142.

The cryogenic pump 142 may be fluidly connected to the cryogenic storage container 110 via an insulated suction line 146. During operation LNG may be drawn through the insulated suction line 146 to an inlet of the cryogenic pump 142. The cryogenic pump 142 operates to raise the pressure of the LNG from below 10 bar to more than 200 bar at an outlet of the cryogenic pump 142. The pressurized LNG may then be processed through the vaporizer 144, where heat from a heat transfer medium, such as air, water, or, in many cases, engine coolant, is used to warm the pressurized LNG to vaporize it for delivery through a high-pressure vaporizer line 148 to an accumulator 150. As shown in FIG. 7, the engine coolant may be circulated to the vaporizer 144 through coolant conduits 152.

The accumulator 150 may store the highly compressed natural gas for regulated delivery to the prime mover source 40 at a precisely controlled pressure. Although shown as being located on the locomotive 10, the accumulator 150 may be located on the tender car 100 and an extended high-pressure fluid line provided to deliver the vaporized LNG to the prime mover source 40. In accordance with yet other aspects of the disclosure, multiple accumulators may be provided to capture and regulate delivery of the pressurized natural gas to the engine. Although shown and described as being delivered to the prime mover source 40 through an accumulator 150, other suitable means for metering and controlling the pressure of delivered compressed natural gas may be used for regulating the pressure and flow of the natural gas injected directly into the combustion chambers.

The locomotive 10 may have a central controller (not shown), that enables monitoring and control of the fuel delivery system via a system of sensors, such as pressure, temperature, volume and flow sensors, to name a few. Included in the system of sensors may be methane detection sensors, methane being the major component of natural gas, that measure the methane levels at select points in the fuel delivery system and signal the central controller if elevated levels of methane are detected somewhere along the fuel delivery route, indicating a possible leak. The controller may be part of a control system integrated with the locomotive computer control and management system.

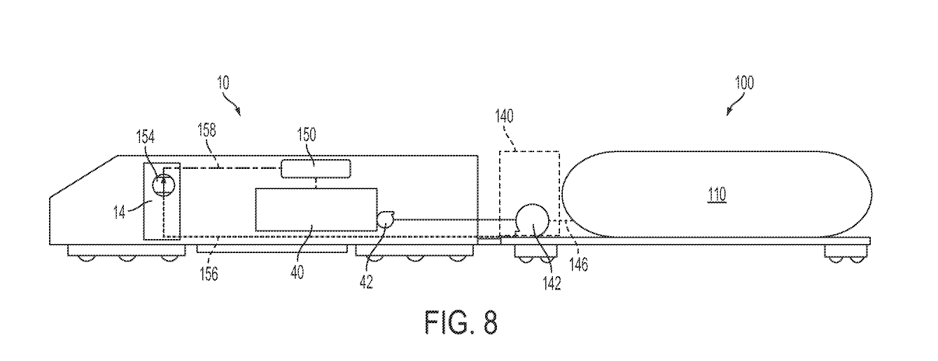

FIG. 8 illustrates a variation of the system described above. To take advantage of the enormous cooling potential of a cryogenically maintained fuel source, an electrical locker heat exchanger 154 may be configured into the electrical locker 14. The electrical locker heat exchanger 154 may thus serve to help directly cool the electrical components therein and transfer heat generated by the electrical equipment therein away from the electrical locker 14. As shown in FIG. 8, the pressurized LNG may be delivered through an insulated, high-pressure line 156 from the cryogenic pump 142 to the electrical locker heat exchanger 154. Heat from the electrical locker 14 is thus drawn into the pressurized LNG flowing through the electrical locker heat exchanger 154 to vaporize the pressurized LNG. The resulting pressurized natural gas may be routed from the electrical locker heat exchanger 154 through a high-pressure feed line 158 to the accumulator 150 for direct injection into the prime mover source 40. The heat exchange system allows simultaneous warming of the pressurized LNG while providing an efficient means for removal of excess heat in the electrical locker 14.

In accordance with other aspects of the present disclosure, the pressurized LNG may not be routed directly to the electrical locker heat exchanger 154. Rather, an intermediary fluid connection may be provided to transfer the heat of the electrical locker 14 into the intermediary fluid via the electrical locker heat exchanger 154 prior to a subsequent transfer of the thermal energy from the intermediary fluid to the LNG at a predetermined location anywhere on the locomotive and/or tender car.

It should be noted that the heat exchange system described herein has certain synergistic characteristics. For example, the ability of the system to provide cooling to the electrical locker 14 may be directly proportional to the heat load necessary to warm the LNG for delivery to the prime mover source 40. As the output of the prime mover source 40 increases, an increased heat load is required to effectively warm the increased volume of LNG being delivered to the prime mover source 40. In most situations, as the output of the prime mover source 40 increases, so too does the heat generated by the components in the electrical locker 14. Thus, aspects of the present disclosure allow for the increased cooling requirements of the electrical locker 14 to scale proportionally with the increased heat load requirements to warm the LNG for delivery the working prime mover source 40. The cooling requirements of the electrical locker 14 typically increase or decrease in proportion to an increase or decrease in the output of the prime mover source 40. Simultaneously, the increase or decrease in fuel demands of the prime mover source 40 increases or decreases the volumetric fuel flow of LNG through the heat exchanger 154. The capability of the heat exchanger 154 to transfer a heat load from the electrical locker 14 to the fuel flow of LNG may thus be scaled appropriately to the amount of LNG flowing through the heat exchanger 154 in accordance with the load requirements of the prime mover source 40.

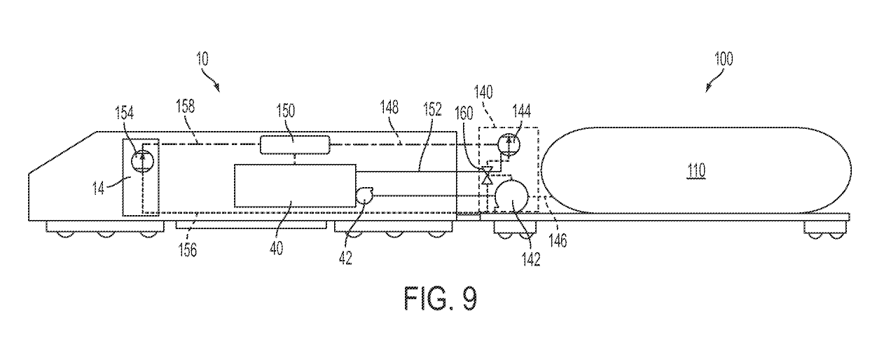

FIG. 9 illustrates yet another variation of a heat exchange system configured for a locomotive 10. The natural gas fuel system shown in FIG. 9 may be configured to provide multiple heat exchange opportunities. For example, the electrical locker heat exchanger 154 may be configured to provide a secondary cooling source for the electrical locker 14 only during when the electrical equipment contained therein is experiencing a high heat loading event, or there may be a desire to maintain the cooling benefits provided by a heat exchange loop with the engine coolant while also providing the cooling benefits provided by a heat exchange loop with the electrical locker 14. As such, the fuel management system 140 may include a diverter valve 160. High pressure LNG may be fed from the cryogenic pump 142 to the diverter valve 160. The diverter valve 160 may be controlled to divert the fluid flow from the cryogenic pump 142 toward either or both of the vaporizer 144 and the electrical locker heat exchanger 154. Both heat transfer loops may individually or in tandem supply high pressure compressed natural gas to the prime mover source 40 while simultaneously providing a cooling source for the engine cooling system and the electrical locker 14.

For example, the controller may cause the diverter valve 160 to close flow to the high-pressure line 156 while opening flow to the vaporizer 144. The pressurized LNG may then be processed through the vaporizer 144, where heat from the engine coolant circulating through the coolant conduits 152 is used to warm the pressurized LNG and vaporize it for delivery through the high-pressure vaporizer line 148 to the accumulator 150. In another state, the controller may control the diverter valve 160 to close flow of high pressure LNG to the vaporizer 144 and open flow of high pressure LNG to the electrical locker heat exchanger 154. Heat from the electrical locker 14 is thus drawn into the pressurized LNG in the electrical locker heat exchanger 154 to vaporize the pressurized LNG and the resulting pressurized natural gas provided through the high-pressure feed line 158 to the accumulator 150 for direct injection into the prime mover source 40. In another state, the controller may control the diverter to open fluid flow of pressurized LNG to both the vaporizer 144 and the electrical locker heat exchanger 154 in which case both heat exchange loops may supply compressed natural gas to the prime mover source 40 through the accumulator 150.

Although described herein as having a diverter valve 160, the same control may be provided via separate solenoid valves, for example, wherein each solenoid valve is controlled to control the individual fluid flow through one of the heat exchange circuits. Multiple cryogenic pumps may be provided with respect to each of the heat exchange circuits.

A temperature sensor in the electrical locker 14 may be used to determine when additional cooling is necessary. For example, when operating the locomotive 10 in a confined space, such as a tunnel, the temperature sensor may detect a spike in the temperature of the electrical locker 14 and send a signal to the controller to divert a portion or all of the pressurized LNG to the electrical locker heat exchanger 154. The electrical locker heat exchanger 154 may thus get the cooling it needs while warming the pressurized LNG to a gaseous state to ensure the prime mover source 40 continues to get the fuel it needs to maintain efficient operation of the locomotive 10.

### INDUSTRIAL APPLICABILITY

The disclosure includes a universally applicable heat exchange system and methods for warming of cryogenic liquid natural gas prior to introduction into an internal combustion engine on a vehicle. The heat exchange system efficiently transfers thermal energy generated by a vehicle's electrical system into a cryogenic liquid natural gas stream. The heat exchange system is disclosed for use on a locomotive, but may be used on other vehicles, including heavy haul trucks, or ships, for example.

The many features and advantages of the disclosure are apparent from the detailed specification, and, thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and, accordingly, all suitable modifications and equivalents may be resorted to that fall within the scope of the disclosure.

What is claimed is:

1. A system for the exchange of thermal energy generated by electrical components in an electrical locker to a flow of a liquefied gas, the system comprising:
a storage container for cryogenically storing the liquefied gas at low pressure;
a heat exchanger configured into the electrical locker; and
a cryogenic pump, in fluid communication with the storage container, for pressurizing the liquefied gas received from the storage container to a higher pressure and for pumping the pressurized liquefied gas to a location where vaporization of the liquefied gas into a gaseous form is performed using the thermal energy drawn from the electrical locker by the heat exchanger.

2. The system of claim 1, wherein the electrical components include an A/C power inverter.

3. The system of claim 1, further comprising an accumulator in fluid communication with the heat exchanger for storing the gaseous form of the liquefied gas.

4. The system of claim 1, wherein the location is the heat exchanger.

5. The system of claim 3, further comprising a prime mover source in fluid communication with the accumulator to receive the gaseous form of the liquefied gas as fuel.

6. The system of claim 5, further comprising a vaporizer in fluid communication with the cryogenic pump for receiving the pressurized liquefied gas from the cryogenic pump and vaporizing the pressurized liquefied gas into a gaseous form with thermal energy from the prime mover source.

7. The system of claim 6, further comprising a coolant system for the prime mover source, wherein the thermal energy is transferred by the vaporizer to the pressurized liquefied gas from a flow of engine coolant cycled through the coolant system.

8. The system of claim 7, further comprising a diverter valve for controlling the flow of pressurized liquefied gas to either or both of the heat exchanger and vaporizer.

9. The system of claim 1, further comprising a hydraulic drive mechanically driven by the prime mover source to hydraulically actuate the cryogenic pump.

10. The system of claim 1, further comprising an intermediary fluid and an intermediary fluid connection to the heat exchanger, wherein the intermediary fluid is routed through the intermediary fluid connection to draw heat from the electrical locker prior to a subsequent thermal exchange with the liquefied gas at the location.

11. A vehicle, comprising:
an electrical locker for housing electrical components;
a storage container for cryogenically storing a liquefied gas at low pressure;
a heat exchanger configured into the electrical locker for exchanging thermal energy generated by the electrical components in the electrical locker with a flow of the liquefied gas; and
a cryogenic pump, in fluid communication with the storage container and the heat exchanger, for pressurizing the liquefied gas received from the storage container to a higher pressure and for pumping the pressurized liquefied gas to the heat exchanger for vaporization of the liquefied gas into a gaseous form using the thermal energy drawn from the electrical locker.

12. The vehicle of claim 11, wherein the vehicle is a locomotive and a tender car connected to the locomotive by a coupling.

13. The vehicle of claim 12, further comprising an internal combustion engine, wherein the electrical locker and the internal combustion engine are on the locomotive and the storage container and the cryogenic pump are on the tender car.

14. The vehicle of claim 12, wherein a conduit for the flow of the pressurized liquefied gas from the cryogenic pump to the heat exchanger is configured into the coupling.

15. A method of supplying gaseous fuel to a prime mover source on a locomotive, the method comprising:
pumping liquefied gas from a storage container on a tender car to a heat exchanger configured into an electrical locker on the locomotive;
vaporizing the liquefied gas in the heat exchanger using thermal energy drawn from the electrical locker; and
injecting the vaporized liquefied gas into the prime mover source.

16. The method of claim 15, wherein the liquefied gas is natural gas.

17. The method of claim 15, further comprising collecting the vaporized liquefied gas in an accumulator.

18. The method of claim 15, further comprising pumping the liquefied gas from the storage container on the tender car to a vaporizer.

19. The method of claim 18, further comprising:
circulating engine coolant through the prime mover source; and
vaporizing the liquefied gas with heat drawn from the engine coolant.

20. The method of claim 18, further comprising diverting the flow of liquefied gas to one or both of the heat exchanger and vaporizer based on a signal received from a controller.
